(19) United States
(12) Patent Application Publication
(10) Pub. No.: US 2026/0257731 A1
(43) Pub. Date: Sep. 3, 2026

(54) FRONT STRUCTURE OF A MOTOR VEHICLE

(71) Applicant: FLEXIS, BOULOGNE-BILLANCOURT (FR)

(72) Inventors: Sébastien BOURDET, GUYANCOURT (FR); Christian DELORD, VILLIERS-SAINT-FREDERIC (FR)

(21) Appl. No.: 19/553,938

(22) Filed: Mar. 2, 2026

(30) Foreign Application Priority Data
Mar. 3, 2025 (FR) FR2502125

(51) Int. Cl. B62D 25/08; B60K 11/04; B62D 21/03; B62D 27/06

(52) U.S. Cl. CPC B62D 25/084; B60K 11/04; B62D 21/03; B62D 27/065

(57) ABSTRACT

A front structure of a motor vehicle, includes; a side member, including an outer sidewall and an upper face; an upper crossmember; a radiator; and a lateral arrangement including: a crossmember support including an intermediate part and a lower part; a secondary support including a lower zone and an upper zone; the lower zone being in contact with the side member; the upper zone protruding above the side member; a structural fixing including a rod passing through the outer sidewall of the side member and the lower part of the crossmember support; and a secondary fixing including a second rod passing through the intermediate part of the crossmember support and the upper zone of the secondary support.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to a front structure of a motor vehicle, of the type including; a first side member extending according to a horizontal longitudinal direction; said first side member including; an outer sidewall, substantially vertical; and an upper face, substantially horizontal; an upper crossmember extending according to a horizontal transverse direction, perpendicular to the longitudinal direction; and a radiator extending substantially vertical and substantially parallel to the transverse direction, an upper end of said radiator being fixed to the upper crossmember.

### BACKGROUND

It is known to fix the upper crossmember, supporting the radiator, to the front edges of the front ends of the side members. However, certain configurations of front structures require installing fixings at the lateral sidewalls of said side members for said upper crossmember.

However, in the event of an impact to the vehicle, the side members are intended to compress in order to effectively absorb the impact energy. The presence of fixings in the lateral sidewalls of the side members locally increases their stiffness, thereby reducing their ability to compress.

### SUMMARY

The present disclosure aims to propose an effective assembly of the upper crossmember and the lateral sidewalls of the side members, without affecting the compressibility of said side members.

To this end, the present disclosure has as its object a front structure of the aforementioned type, further comprising a first lateral arrangement, said first lateral arrangement including; a crossmember support formed by a plate, substantially vertical and substantially parallel to the longitudinal direction; said crossmember support comprising an upper part, an intermediate part and a lower part, formed in one piece and aligned according to the vertical; a first end of the upper crossmember being fixed to the upper part of said crossmember support; a secondary support comprising a first lower zone and a first upper zone, adjacent to each other according to the vertical; the first lower zone being fixed in contact with the first side member; the first upper zone protruding relative to the upper face of said first side member; a structural fixing comprising a first rod passing through both the outer sidewall of the first side member and the lower part of the crossmember support; and at least one first secondary fixing comprising a second rod passing through both the intermediate part of the crossmember support and the first upper zone of the secondary support.

According to other advantageous aspects of the present disclosure, the front structure includes one or more of the following features, taken alone or in any technically possible combination:

the first lower zone of the secondary support is in contact with the lower part of the crossmember support; and the first rod of the structural fixing also passes through said first lower zone of the secondary support;

the first lower zone of the secondary support is spaced away from the lower part of the crossmember support according to the longitudinal direction;

the secondary support further comprises a second lower zone and a second upper zone, adjacent to each other according to the vertical; the second lower zone being fixed in contact with the first side member; the second upper zone protruding relative to the upper face of said first side member; the second lower and upper zones being spaced apart from the first lower and upper zones according to the longitudinal direction; and the first lateral arrangement further includes a second secondary fixing, said second secondary fixing comprising a third rod passing through both the intermediate part of the crossmember support and the second upper zone of the secondary support;

the structural fixing and the first and second secondary fixings form a non-flat triangle;

the first and second lower zones of the secondary support are spaced apart by a non-zero distance according to the longitudinal direction;

the structural fixing comprises; a screw comprising the first rod and an enlarged head; and a nut able to cooperate with the screw, the nut being removable relative to the first side member;

the front structure further comprises; a second side member extending according to the longitudinal direction; said second side member including; an outer sidewall, substantially vertical; and an upper face, substantially horizontal; and a second lateral arrangement fixedly connecting a second end of the upper crossmember and the second side member;

the first and second lateral arrangements are substantially symmetrical to each other relative to a median plane of said front structure, parallel to the longitudinal direction.

The present disclosure also relates to a motor vehicle comprising a front structure such as described above.

### BRIEF DESCRIPTION OF THE DRAWINGS

The present disclosure will appear more clearly upon reading the following description, given solely by way of non-limiting example, and made with reference to the drawings in which:

FIG. 1 is a perspective view of a front structure of a vehicle according to one embodiment of the present disclosure; and

FIGS. 2 and 3 are detailed sectional views of the front structure of FIG. 1.

### DETAILED DESCRIPTION

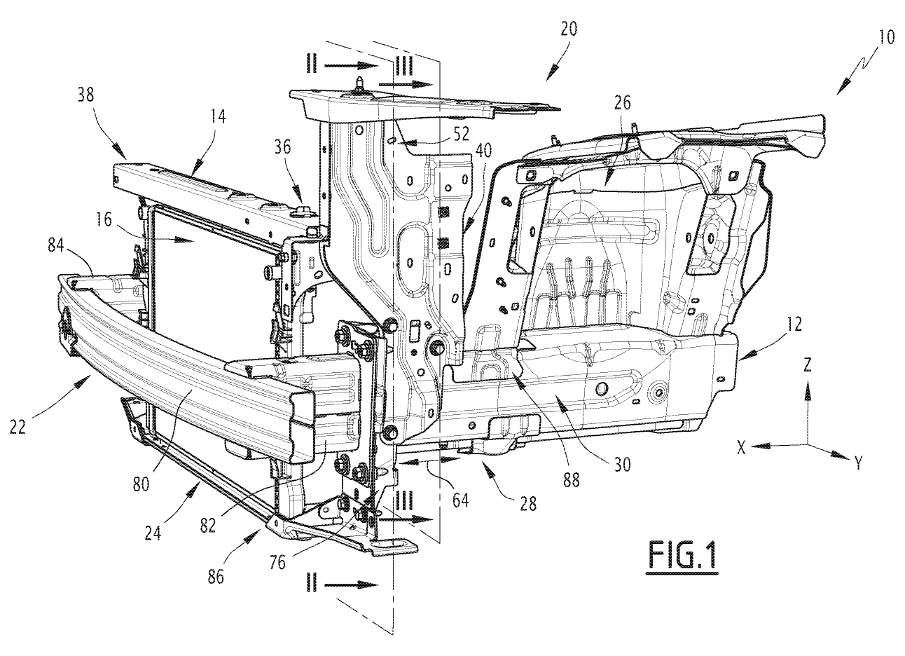

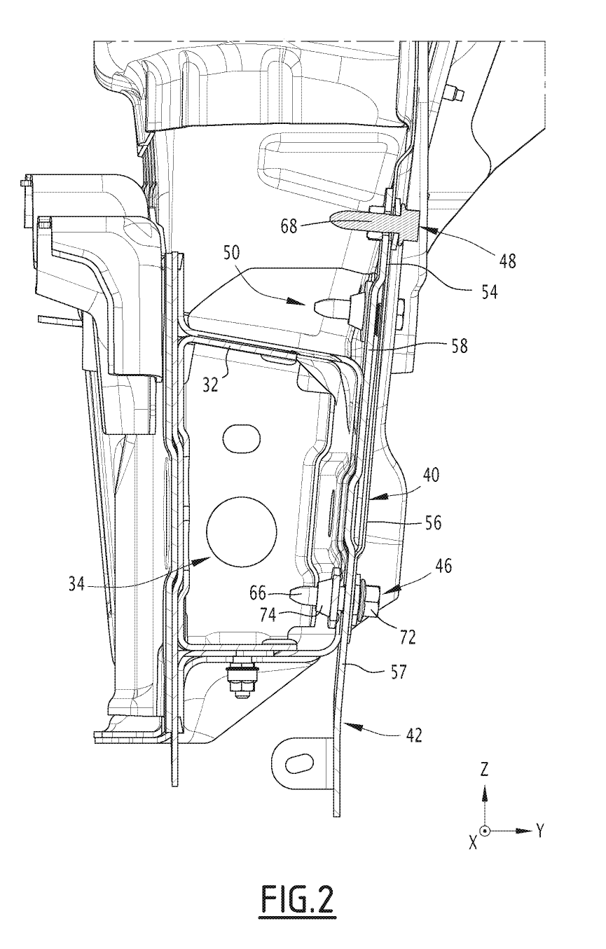

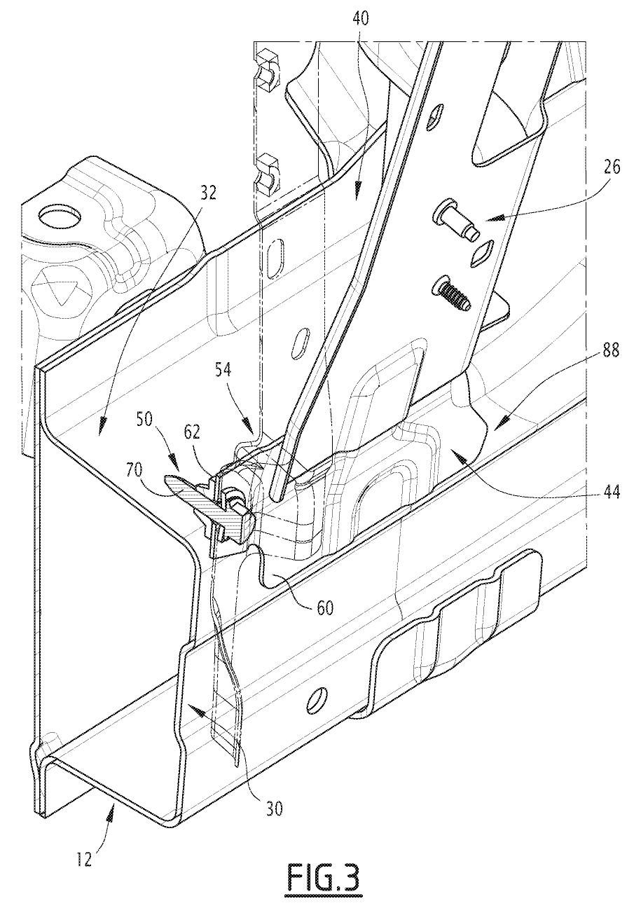

FIG. 1 shows a front structure 10 according to one embodiment of the present disclosure. The front structure 10 is notably intended to be integrated into a motor vehicle (not represented).

The front structure 10 comprises notably; a first side member 12; an upper crossmember 14; a radiator 16; and a first lateral arrangement 20.

In the embodiment represented, the front structure 10 further comprises; a front crossmember 22; a lower crossmember 24; and a strut-tower riser 26.

The first side member 12 extends according to a horizontal longitudinal direction X to a front end 28. The longitudinal direction X corresponds to a direction of travel of the motor vehicle.

In the remainder of the description, an orthonormal frame (X, Y, Z) associated with the front structure 10 is considered, the Z direction representing the vertical. The Y direction is referred to as the transverse direction.

The first side member 12 includes an outer sidewall 30 and an upper face 32.

Each of the outer sidewalls 30 and the upper face 32 of the first side member 12 is substantially planar and parallel to the longitudinal direction X. The outer sidewall 30 is substantially vertical; the upper face 32 is substantially horizontal.

The first side member 12 presents a tubular shape, defined notably by the outer sidewall 30 and by the upper face 32. Said tubular shape provides rigidity to the first side member 12. Said tubular shape of the first side member 12 delimits an internal space 34.

The upper crossmember 14 extends in a substantially rectilinear manner according to the transverse direction Y, between a first end 36 and a second end 38.

The radiator 16 has a substantially planar shape, arranged according to a plane (Y, Z). The radiator 16 is arranged below the upper crossmember 14, an upper end of said radiator 16 being fixed to said upper crossmember 14.

The first lateral arrangement 20 will be described later. As will be detailed hereinafter, the first lateral arrangement 20 fixedly connects the first end 36 of the upper crossmember 14 to the front end 28 of the first side member 12.

Preferably, the front structure 10 further comprises a second side member and a second lateral arrangement, not represented. In the remainder of the description, it is considered that said second side member and said second lateral arrangement are symmetrical, respectively, to the first side member 12 and to the first lateral arrangement 20, relative to a median plane (X, Z) of the front structure 10; and that the second lateral arrangement fixedly connects the second end 38 of the upper crossmember 14 to a front end of the second side member.

The outer sidewall 30 of the first side member 12 is oriented opposite said median plane (X, Z).

The first lateral arrangement 20 includes; a crossmember support 40; at least one secondary support 42, 44; a structural fixing 46; and at least one secondary fixing 48, 50.

More specifically, in the embodiment represented, the first lateral arrangement 20 includes: a first 42 and a second 44 secondary supports; and a first 48 and a second 50 secondary fixing.

The crossmember support 40 is formed by a first plate substantially arranged in a plane (X, Z).

Said crossmember support 40 comprises an upper part 52, an intermediate part 54 and a lower part 56, formed in one piece and aligned according to the vertical or vertically herein, the intermediate part 54 being arranged between the upper 52 and the lower 56 parts. The first end 36 of the upper crossmember 14 is fixed in contact with the upper part 52 of the crossmember support 40.

The first secondary support 42 comprises a first lower zone 57 and a first upper zone 58, formed in one piece and adjacent to each other according to the vertical. In the embodiment represented, the first secondary support 42 is formed by a second plate substantially arranged in a plane (X, Z).

The first lower zone 57 of the first secondary support 42 is fixed in contact with the first side member 12, more precisely fixed in contact with the outer sidewall 30 of said first side member. The first upper zone 58 of the first secondary support 42 forms a vertical protrusion above the upper face 32 of said first side member.

In the embodiment represented, the first lower zone 57 of the first secondary support 42 is sandwiched between the outer sidewall 30 of the first side member 12 and the lower part 56 of the crossmember support 40.

The second secondary support 44 comprises a second lower zone 60 and a second upper zone 62, formed in one piece and adjacent to each other according to the vertical. The second lower zone 60 of the second secondary support 44 is fixed in contact with the first side member 12, more precisely fixed in contact with the outer sidewall 30 of said first side member. The second upper zone 62 of the second secondary support 44 forms a vertical protrusion above the upper face 32 of said first side member.

In the embodiment represented, the second secondary support 44 is formed by a third plate, distinct from the second plate forming the first secondary support 42.

The first 42 and the second 44 secondary supports are spaced apart from each other according to the longitudinal direction X. More specifically, the second secondary support 44 is located toward the rear relative to the first secondary support 42.

Even more precisely, at the outer sidewall 30 of the first side member 12, a non-zero distance 64 separates the first 57 and the second 60 lower zones of the first 42 and the second 44 secondary supports according to the longitudinal direction X.

The structural fixing 46 comprises a first rod 66 extending according to Y and passing through both the outer sidewall 30 of the first side member and the lower part 56 of the crossmember support 40. In the embodiment represented, the first rod 66 also passes through the first lower zone 57 of the first secondary support 52, sandwiched between said outer sidewall 30 of the first side member and said lower part 56 of the crossmember support.

The first secondary fastener 48 comprises a second rod 68 extending according to Y and passing through both the intermediate part 54 of the crossmember support and the first upper zone 58 of the first secondary support 42.

In other words, the first secondary fixing 48 is located higher according to Z than the structural fixing 46.

The second secondary fastener 50 comprises a third rod 70 extending according to Y and passing through both the intermediate part 54 of the crossmember support 40 and the second upper zone 62 of the second secondary support 44.

In the embodiment represented, the second secondary fixing 50 is located toward the rear relative to the structural fastener 46 and to the first secondary fixing 48; and the structural fixing 46 and the first 48 and the second 50 secondary fixings form a non-flat triangle. The assembly of the crossmember support 40 to the first side member 12 is thus reinforced.

In the embodiment represented, the rods 66, 68, 70 of each of the structural fixings 46 and the first 48 and the second 50 secondary fixings is a threaded rod; and each of the structural fixings 46 and the first 48 and the second 50 secondary fixings further comprises; an enlarged head 72 integral with one end of the corresponding threaded rod 66, 68, 70 to form a screw; and a nut 74 able to cooperate with the corresponding threaded rod 66, 68, 70.

In the embodiment represented, the nut 74 of the structural fixing 46 is arranged in the internal space 34 of the first side member 12.

Preferably, the nut 74 of the structural fixing 46 is removable relative to the outer sidewall 30 of the first side member 12. More precisely, the nut 74 of the structural fixing 46 is preferably not welded to said outer sidewall 30.

In the embodiment represented, the first secondary support 42 is integrated into a reinforcement 76 of the front end 28 of the first side member 12. More precisely, said reinforcement 76 presents a substantially L-shaped section in a horizontal plane, one branch of the L parallel to X being formed by the first secondary support 42.

More precisely, in the embodiment represented, the front crossmember 22 of the front structure 10 comprises; a main portion 80 extending substantially according to the transverse direction Y in front of the radiator 16; and the first 82 and the second 84 arms extending according to X toward the rear, respectively from the first and the second ends of the main portion 80. A free end of the first arm 82 is assembled to the front end 28 of the first side member 12 and to the reinforcement 76.

Furthermore, in the embodiment represented, the lower crossmember 24 of the front structure 10 is fixed to a lower end of the radiator 16 and extends according to X between a first end 86 and a second end. Said first end 86 of the lower crossmember 24 is fixed to the reinforcement 76 of the front end 28 of the first side member 12.

Furthermore, in the embodiment represented, the second secondary support 44 is integrated into a strut-tower riser support 88. More precisely, the strut-tower riser 26 of the front structure 10 is fixed to the second upper zone 62 of the second secondary support 44.

In the configuration of the front structure 10 described above, although the structural fastener 46 and the first 48 and the second 50 secondary fixings solidly assemble the crossmember support 40 to the rest of the structure, only the first rod 66 of the structural fixing 46 passes through the first side member 12. Away from the first 57 and the second 60 lower zones of the first 42 and the second 44 secondary supports, the front of the first side member 12 thus retains a compressible length, notably over the non-zero distance 64 between the said first 42 and second 44 secondary supports.

The nut 74, not welded, of the structural fixing 46 also contributes to preserving the compressibility of the front of the first side member 12. The safety of the motor vehicle is thus improved.

The front structure 10 described above thus allows the upper crossmember 14 to be fixed to the outer sidewall 30 of the side member 12, while preserving the compressibility of said side member in the event of an impact to the vehicle.

What is claimed is:

1. A front structure of a motor vehicle comprising:
a first side member extending according to a horizontal longitudinal direction, the first side member comprising an outer sidewall, substantially vertical, and an upper face, substantially horizontal;
an upper crossmember extending according to a horizontal transverse direction, perpendicular to the longitudinal direction;
a radiator extending substantially vertical and substantially parallel to the transverse direction, an upper end of said radiator being fixed to the upper crossmember; and
a first lateral arrangement comprising:
a crossmember support formed by a plate substantially vertical and substantially parallel to the longitudinal direction, the crossmember support comprising an upper part, an intermediate part, and a lower part, formed in one piece and aligned vertically, a first end of the upper crossmember being fixed to the upper part of said crossmember support;
a secondary support comprising a first lower zone and a first upper zone, adjacent to each other vertically, the first lower zone being fixed in contact with the first side member, the first upper zone protruding relative to the upper face of said first side member;
a structural fixing comprising a first rod passing through both the outer sidewall of the first side member and the lower part of the crossmember support; and
at least one first secondary fixing comprising a second rod passing through both the intermediate part of the crossmember support and the first upper zone of the secondary support.

2. The front structure according to claim 1, wherein the first lower zone of the secondary support is in contact with the lower part of the crossmember support, and the first rod of the structural fixing passes through said first lower zone of the secondary support.

3. The front structure according to claim 1, wherein the first lower zone of the secondary support is spaced apart from the lower part of the crossmember support according to the longitudinal direction.

4. The front structure according to claim 2, wherein:
the secondary support further comprises a second lower zone and a second upper zone, adjacent to each vertically, the second lower zone being fixed in contact with the first side member, the second upper zone protruding relative to the upper face of said first side member, the second lower and upper zones being spaced apart from the first lower and upper zones according to the longitudinal direction; and
the first lateral arrangement further comprises a second secondary fixing, the second secondary fixing comprising a third rod passing through both the intermediate part of the crossmember support and the second upper zone of the secondary support.

5. The front structure according to claim 4, wherein the structural fixing and the first and second secondary fixings form a non-flat triangle.

6. The front structure according to claim 4, wherein the first and second lower zones of the secondary support are spaced apart by a non-zero distance according to the longitudinal direction.

7. The front structure according to claim 1, wherein the structural fixing comprises a screw and a nut, the screw comprising the first rod and an enlarged head, the nut configured to cooperate with the screw, the nut being removable relative to the first side member.

8. The front structure according to claim 1, further comprising:
a second side member extending according to the longitudinal direction, the second side member comprising an outer sidewall, substantially vertical, and an upper face, substantially horizontal; and
a second lateral arrangement fixedly connecting a second end of the upper crossmember and the second side member.

9. The front structure according to claim 8, wherein the first and second lateral arrangements are substantially symmetrical to each other relative to a median plane of said front structure, parallel to the longitudinal direction.

10. A motor vehicle comprising the front structure according to claim 1.
